(19) United States
(12) Patent Application Publication
(10) Pub. No.: US 2013/0300143 A1
(43) Pub. Date: Nov. 14, 2013

(54) TRUCK BED PAYLOAD SUPPORT AND METHOD OF USE

(71) Applicant: JAMES DUNN, Kennewick, WA (US)

(72) Inventor: JAMES DUNN, Kennewick, WA (US)

(21) Appl. No.: 13/890,772

(22) Filed: May 9, 2013

Related U.S. Application Data
(60) Provisional application No. 61/646,114, filed on May 11, 2012.

(51) Int. Cl. B60R 9/00

(52) U.S. Cl. CPC B60R 9/00
USPC 296/3

(57) ABSTRACT

A Truck Bed Payload Support having a plurality of side stakes having a horizontal bar extending between the side stakes. The side stakes fitted into the rear truck side stake holes. Legs supporting the horizontal bar where the legs rest on the truck bed. The horizontal bar is higher than the tailgate and truck side beds.

### FIELD OF THE INVENTION

This Patent Application is pending from Provisional Application 61/646,114 filed May 11, 2012. This invention relates to transport of materials and loads in a truck bed without impeding the operation of a gate at or near the rear of the truck bed.

### BACKGROUND OF THE INVENTION

Prior art shows truck payloads to be supported by the tailgate. This means the tailgate cannot be opened and closed freely and will be damaged if overloaded. The other racks are over the cab racks. Also they rest on the top of the side rails of the truck. Overloading will damage the sides of the truck. Rack fits into the rear stake holes of the truck bed. The size of the rack makes it easy to install and uninstall and load material.

The patents and publications referred to herein are provided herewith in an Information Disclosure Statement in accordance with 37 CFR 1.97.

### SUMMARY OF THE INVENTION

Payloads longer than a truck bed are frequently supported by a tailgate. This restricts use of the tailgate limiting the opening and closing of the tailgate and potentially resulting in damage. This invention solves this problem. A horizontal bar, supported by two legs, supports the payload freeing the tailgate to be operated normally. Side stakes, fitting into the rear stake holes of a truck bed, secures the structure relative to a truck bed and tailgate. The claimed invention differs from what currently exists as seen in disclosed prior inventions. This disclosure protects the tailgate and does not rest on the trucks side rails or tailgate. The device is adjustable to fit each truck manufacturer. The size of the rack makes it easy to install and uninstall. Loading via the structure leaves the truck bed free for the storage and carriage of other materials.

The Version of the Invention Discussed Here Includes:
1. Tubular materials including Square metal cross-section tubing.

2. Nuts, washers and bolts

3. Plastic square caps

4. Metal plate

Relationship Between the Components:

(1) Square metal is welded together to make the shapes needed to be (2) bolted together to make the rack. (4) Metal plate welded to support legs and all open ends are (3) capped off which is optional.

How the Invention Works:

Two side stakes extend vertical above and below the horizontal bar at each end of the bar. The lower part of the side stake slides into the rear stake hole of the truck bed keeping the rack in place. The upper part of the side stake helps contain the payload. The two side stakes slide into t he horizontal bar and are bolted to it after choosing the correct mounting hole provided. This allows the side stakes to be adjusted to fit the make and model of the truck it is being installed on. Support legs are bolted to the horizontal bar at a specific height to keep the horizontal bar off of the side rail of the truck. The support legs also transfer the weight of the load to the truck bed where a metal plate helps distributes the load. By supporting the payload the tailgate can be used freely.

How to Make the Invention:

Once the square metal, metal plate, nuts and bolts are procured. The metal needs to be cut to length and welded. Holes need to be drilled where needed for construction of the rack. All metal parts need to be painted or powder coated. Nuts, washers, bolts and end caps need to be bagged together for shipment. All parts need to be packaged for shipping and sales. This all could be done by oneself if you have a welder; chop saw, grinder and painting equipment. The rack could be outsourced to a metal fabricator, painter and packing firm who specialize in these fields. Plastic end caps are optional.

How to Use the Invention:

After you assemble the rack, open the tailgate and guide the side stakes of the rack into the stake holes on the truck. Load your payload and operate your tailgate freely.

### BRIEF DESCRIPTION OF THE FIGURES

The foregoing and other features and advantages of the present invention will become more readily appreciated as the same become better understood by reference to the following detailed description of the preferred embodiment of the invention when taken in conjunction with the accompanying drawings, wherein:

FIGS. 1, 2 and 3 show the assembled Truck Bed Payload Support illustrating the side stakes (10), horizontal bar (12) and vertical support (14). FIG. 3 additionally shows the exemplary fasteners (30).

FIG. 4 illustrates the side stakes (10), horizontal bar (12), vertical support (14), vertical support base plate (16), horizontal bar leg (18), side stake male leg (20), horizontal bar hole (22), vertical support hole (24), exemplary truck (26), exemplary truck tailgate (28), exemplary fastener (30), exemplary fastener apertures (31) and the device assembly (32).

### DETAILED DESCRIPTION OF THE INVENTION

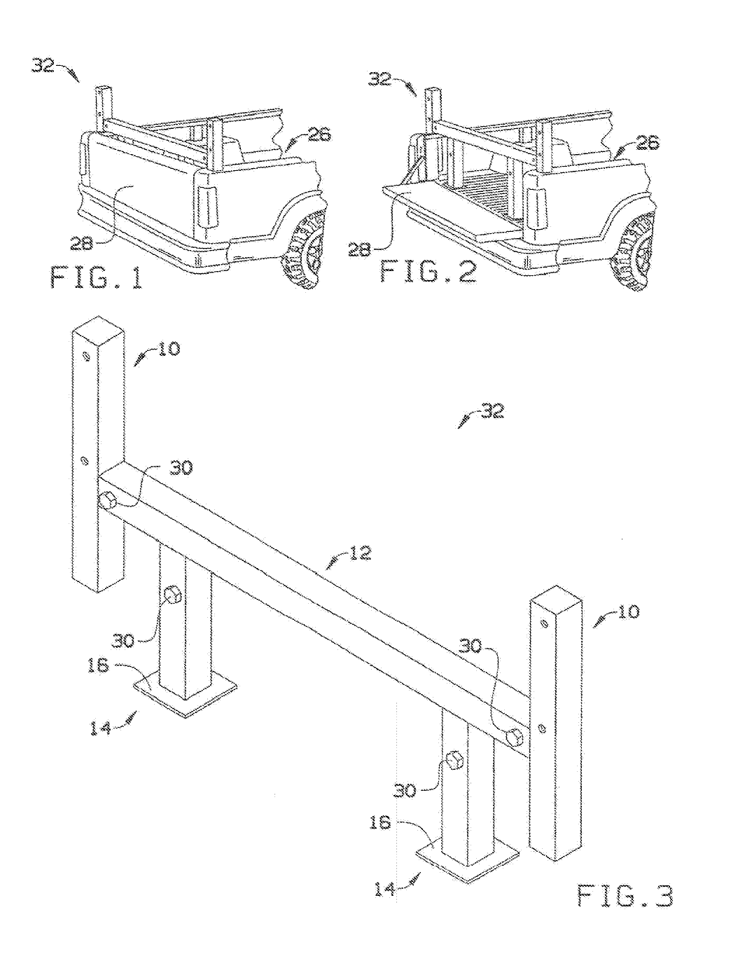

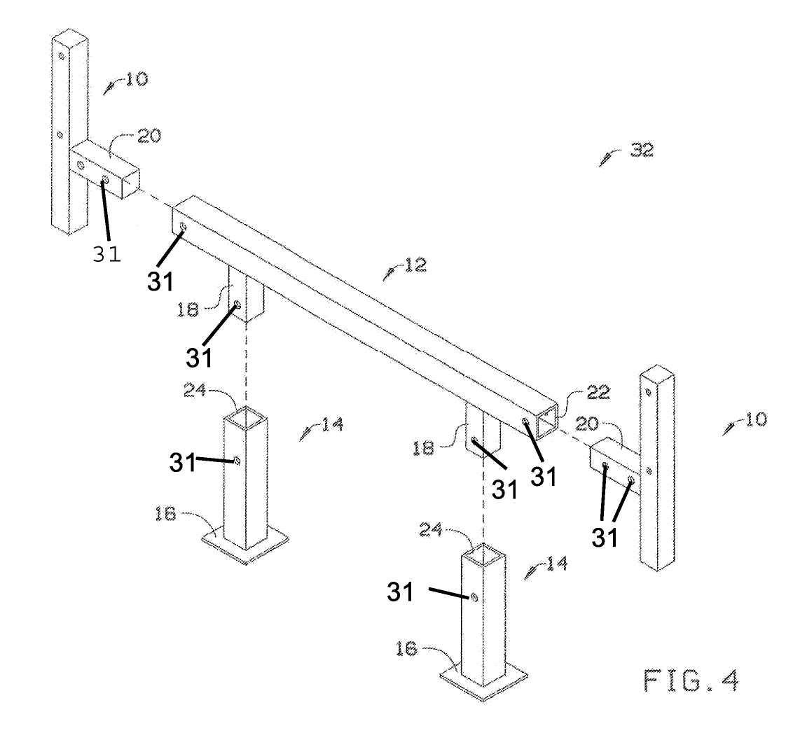

The preferred embodiment of the apparatus of this disclosure is seen in FIG. 1 through 4. FIGS. 1 and 2 show a Truck Bed Payload Support comprising a plurality of side stakes (10) which are interconnected by at least one horizontal bar (12) where each of the said plurality of side stakes (10) are sized to be received into an exemplary truck bed vertical support hole (22) and each of the said plurality of side stakes (10) are received into a truck bed vertical support hole (22).

The at least one horizontal bar (12) is fixedly interconnected, upwardly distal from the truck bed vertical support hole and upwardly distal from an exemplary truck tailgate (28), to the each of the plurality of side stakes (10). The truck bed vertical support hole (22) is upwardly extending. At least one horizontal bar leg (18) is downwardly extending from and fixedly attached to the at least one horizontal bar (12). At least one vertical support (14) is fixedly attached to and downwardly extending toward the truck bed from the at least one horizontal bar leg (18). The said at least one vertical support (14) terminates most distal from the at least one horizontal bar (12) in a vertical support base plate (16) resting on a truck bed.

A side stake leg (20) is outwardly extending from and fixedly attached to each of the plurality of side stakes (10). The side stake leg (20) is outwardly extending toward the other of the plurality of side stakes (10). The plurality of side stakes (10), side stake leg (20), the horizontal bar (12), the horizontal bar leg (18) and the vertical support (14) are tubular and are constructed generally from metals or other rigid materials. The vertical support base plate (16) is essentially flat and constructed of metal or other rigid material. The horizontal bar leg (18), which is fixedly attached to the at least one horizontal bar (12), and the side stake leg (20), which is fixedly attached to the plurality of side stakes (10), is generally fixed by exemplary fasteners (30) including welding, nut/bolt, screw or rivets. The tubular downwardly extending horizontal bar leg (18) is sized to fit into the vertical support (14) or is sized to receive the vertical support (14) into the horizontal bar leg (18). The tubular outwardly extending side stake leg (20) is sized to fit into the horizontal bar (12) at a horizontal bar hole (22) or is sized to receive the horizontal bar (12) into the tubular side stake leg (20).

In the preferred embodiment the plurality of side stakes (20) are comprised of two side stakes (20) and the at least one horizontal bar (12) is one horizontal bar (12); the at least one vertical support (14) is two vertical supports (14) which are disposed intermediate the two side stakes (20).

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims.

I claim:

1. A Truck Bed Payload Support comprising:
a plurality of side stakes (10) are interconnected by at least one horizontal bar (12); and
each of the said plurality of side stakes (10) are sized to be received into an exemplary truck bed vertical support hole (22) and each of the said plurality of side stakes (10) are received into a truck bed vertical support hole (22).

2. The Truck Bed Payload Support of claim 1 further comprising:
the at least one horizontal bar (12) is fixedly interconnected, upwardly distal from the truck bed vertical support hole and upwardly distal from an exemplary truck tailgate (28), to the each of the plurality of side stakes (10); and
the truck bed vertical support hole (22) is upwardly extending.

3. The Truck Bed Payload Support of claim 2 further comprising:
at least one horizontal bar leg (18) is downwardly extending from and fixedly attached to the at least one horizontal bar (12); and
at least one vertical support (14) fixedly attached to and downwardly extending toward the truck bed from the at least one horizontal bar leg (18); and
the said at least one vertical support (14) terminates most distal from the at least one horizontal bar (12) in a vertical support base plate (16) resting on a truck bed.

4. The Truck Bed Payload Support of claim 3 further comprising:
a side stake leg (20) outwardly extending from and fixedly attached to each of the plurality of side stakes (10); the side stake leg (20) is outwardly extending toward the other of the plurality of side stakes (10); and
the plurality of side stakes (10), side stake leg (20), the horizontal bar (12), the horizontal bar leg (18) and the vertical support (14) are tubular and are constructed generally from metals or other rigid materials; and
the vertical support base plate (16) is essentially flat and constructed of metal or other rigid material.

5. The Truck Bed Payload Support of claim 4 further comprising:
the horizontal bar leg (18), which is fixedly attached to the at least one horizontal bar (12), and the side stake leg (20), which is fixedly attached to the plurality of side stakes (10), is generally fixed by exemplary fasteners (30) including welding, nut/bolt, screw or rivets; and
the tubular downwardly extending horizontal bar leg (18) is sized to fit into the vertical support (14) or is sized to receive the vertical support (14) into the horizontal bar leg (18); and
the tubular outwardly extending side stake leg (20) is sized to fit into the horizontal bar (12) at a horizontal bar hole (22) or is sized to receive the horizontal bar (12) into the tubular side stake leg (20).

6. The Truck Bed Payload Support of claim 5 further comprising:
the plurality of side stakes (20) are comprised of two side stakes (20) and the at least one horizontal bar (12) is one horizontal bar (12); the at least one vertical support (14) is two vertical supports (14) which are disposed intermediate the two side stakes (20).
